(19) United States
(12) Patent Application Publication
(10) Pub. No.: US 2011/0299557 A1
(43) Pub. Date: Dec. 8, 2011

(54) Side Fire Laser Assembly With Diffractive Portion

(75) Inventor: Ty Fairneny, Hopkinton, MA (US)

(73) Assignee: Boston Scientific Scimed, Inc.

(21) Appl. No.: 13/113,778

(22) Filed: May 23, 2011

Related U.S. Application Data
(60) Provisional application No. 61/351,519, filed on Jun. 4, 2010.

(51) Int. Cl. H01S 3/30

(52) U.S. Cl. 372/6

(57) ABSTRACT

Embodiments include an apparatus including an optical fiber having a distal end with a distal surface configured to emit a beam of energy at an angle relative to a longitudinal axis of the optical fiber. The apparatus also includes a tube including a channel and a diffractive portion. The distal end of the optical fiber is disposed in the channel of the tube such that the beam of energy emitted from the optical fiber passes through the diffractive portion. The beam of energy emitted from the diffractive portion has a greater beam angle than the beam of energy directed to the diffractive portion.

This application claims the benefit of priority from U.S. Provisional Application No. 61/351,519, filed Jun. 4, 2010, which is herein incorporated by reference in its entirety.

### FIELD

Embodiments of the invention include medical devices and more particularly medical devices including a side fire laser assembly with a diffractive portion and related methods of use.

### BACKGROUND

Side fire laser assemblies may be used for laser-based surgical procedures, for example, to deliver laser energy of a specific wavelength at a specific pulse rate to remove tissue through vaporization. Such procedures may be performed in an aqueous environment, for example, within water.

FIG. 1 shows a conventional side fire laser assembly 100 including a side fire optical fiber 130. An end 132 of the optical fiber 130 may be polished at a specific angle such that energy is emitted to a side of the optical fiber 130, as opposed to the end. To permit the laser to emit energy at the correct angle, an air interface is provided at the polished end 132 of the optical fiber 130. As shown in FIG. 1, an air gap 160 is formed in the conventional laser assembly 100 when a capillary tube 150 is fused onto the optical fiber 130 and an end 152 of the capillary tube 150 is heated until the end of the capillary tube 150 collapses, thereby forming a seal that encloses the air gap 160.

For prostate surgery, the conventional side fire laser assembly 100 may be inserted into a cystoscope. A need exists to decrease the size of instruments used for prostate surgery, such as cameras and cystoscopes. Accordingly, there is also a need to decrease the size of the side fire laser assembly 100 so that the side fire laser assembly 100 may fit into the smaller cystoscopes. One way to decrease the size of the side fire laser assembly 100 is to decrease the size of its components, such as the diameter of the optical fiber 130. Decreasing the diameter of the optical fiber 130, however, produces a smaller beam of laser energy. As a result, each pulse of energy emitted from the smaller optical fiber 130 can treat a smaller area of tissue, thereby requiring more time to complete a procedure. Accordingly, a need exists to decrease the size of a laser assembly without having a corresponding decrease in the size of the beam of laser energy produced by the laser assembly.

It is to be understood that both the foregoing general description and the following detailed description are exemplary and explanatory only and are not restrictive of the invention.

### SUMMARY

In accordance with an embodiment, an apparatus includes an optical fiber having a distal end with a distal surface configured to emit a beam of energy at an angle relative to a longitudinal axis of the optical fiber. The apparatus also includes a tube including a channel and a diffractive portion. The distal end of the optical fiber is disposed in the channel of the tube such that the beam of energy emitted from the optical fiber passes through the diffractive portion. The beam of energy emitted from the diffractive portion has a greater beam angle than the beam of energy directed to the diffractive portion.

In accordance with another embodiment, a method of transmitting a beam of energy includes transmitting a beam of energy through an optical fiber and toward a distal end of the optical fiber. The distal end of the optical fiber is disposed within a channel in a tube. The method also includes emitting the beam of energy from the optical fiber at an angle relative to a longitudinal axis of the optical fiber and transmitting the beam of energy through a diffractive portion to increase a beam angle of the beam of energy.

In accordance with a further embodiment, a laser assembly includes a laser source configured to produce a beam of energy and an optical fiber having a proximal end coupled to the laser source and a distal end. The distal end of the optical fiber has a distal surface configured to emit the beam of energy at an angle relative to a longitudinal axis of the optical fiber. The laser assembly also includes a tube including a channel and a diffractive portion. The distal end of the optical fiber is disposed in the channel of the tube such that the beam of energy emitted from the optical fiber passes through the diffractive portion of the tube. The diffractive portion is configured to increase a beam angle of the beam of energy.

Additional objects and advantages of the invention will be set forth in part in the description which follows, and in part will be obvious from the description, or may be learned by practice of the invention. The objects and advantages of the invention will be realized and attained by means of the elements and combinations particularly pointed out below.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a cross-sectional view of a distal end portion of a conventional laser assembly;

FIG. 2 is a schematic view of a laser assembly, according to an exemplary embodiment of the invention;

FIG. 3 is a cross-sectional view of a distal end portion of the laser assembly of FIG. 2;

FIG. 4 is a partial cross-sectional view of a capillary tube and optical fiber of the laser assembly of FIGS. 2 and 3, taken along line A-A of FIG. 3; and

FIGS. 5 and 6 are partial cross-sectional views of various exemplary embodiments of diffractive surfaces of the capillary tube of the laser assembly of FIG. 2.

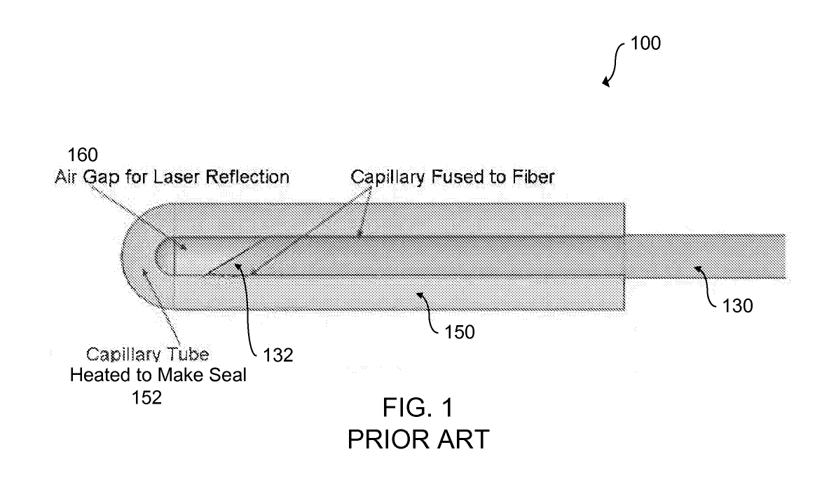

### DESCRIPTION OF THE EMBODIMENTS

Reference will now be made in detail to exemplary embodiments of the invention, examples of which are illustrated in the accompanying drawings. Wherever possible, the same reference numbers will be used throughout the drawings to refer to the same or like parts.

The terms “proximal” and “distal” are used herein to refer to the relative positions of the components of an exemplary laser assembly 10. When used herein, “proximal” refers to a position relatively closer to the exterior of the body, or closer to the surgeon or other user using the laser assembly 10. In contrast, “distal” refers to a position relatively further away from the surgeon or other user using the laser assembly 10, or closer to the interior of the body.

The devices and methods described herein are generally related to the use of side-firing optical fibers within the body of a patient. For example, the devices and methods may be suitable for use in treating symptoms related to an enlarged prostate gland, such as a condition known as Benign Prostatic Hyperplasia (BPH). BPH is a common condition in which the prostate becomes enlarged with aging. Laser-based surgical procedures employing side-firing optical fibers and high-power lasers may be used to remove obstructing prostate tissue, e.g., associated with BPH. In these procedures, a doctor may pass the optical fiber through the urethra using a cystoscope, a specialized endoscope with a small camera on the end, and then may deliver multiple pulses of laser energy to destroy some of the enlarged prostate tissue and to shrink the size of the prostate. The devices and methods described herein may be used to treat conditions of the body other than BPH, such as, for example, endometriosis, gastro-esophagus reflux diseases (GERD), and/or tumors (e.g., breast cancer tumors).

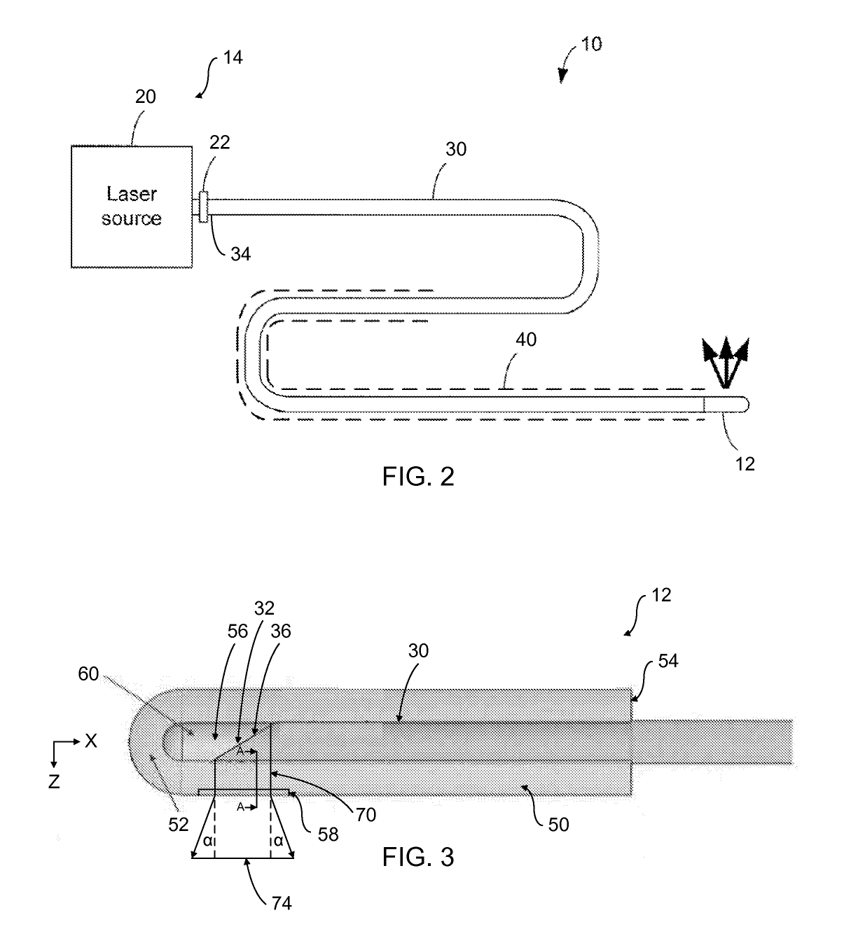

FIG. 2 is a schematic drawing of a side fire laser assembly 10 according to an exemplary embodiment. The laser assembly 10 may include a distal end portion 12 and a proximal end portion 14. The laser assembly 10 may also include a laser source 20 and an optical fiber 30. The laser source 20 may be located in the proximal end portion 14 of the laser assembly 10, and the optical fiber 30 may extend between and into the proximal and distal end portions 12, 14 of the laser assembly 10. The laser assembly 10 may be used to transmit laser energy from the laser source 20 to a target treatment area within a patient's body, e.g., near the distal end portion 12 of the laser assembly 10.

The laser source 20 may include at least one laser that may be used to generate laser energy for surgical procedures. The laser source 20 may include at least one of, for example, a Ho:YAG laser, a neodymium-doped:YAG (Nd:YAG) laser, a semiconductor laser diode, or a potassium-titanyl phosphate crystal (KTP) laser. The laser source 20 may include more than one laser, and more than one laser may be used during a surgical procedure. The laser source 20 may also include a processor that provides timing, wavelength, and/or power control of the laser(s). For example, the laser source 20 may include one or more mechanisms for laser selection, filtering, temperature compensation, and/or Q-switching operations.

The optical fiber 30 may include a distal end 32 (FIG. 3) and a proximal end 34. The proximal end 34 of the optical fiber 30 may be coupled to the laser source 20 in the proximal end portion 14 of the laser assembly 10. For example, the proximal end 34 of the optical fiber 30 may be coupled to the laser source 20 through an optical coupler 22 in or near the proximal end portion 14 of the laser assembly 10. The optical coupler 22 may be, for example, an SMA (SubMiniature version A) connector. The proximal end 34 of the optical fiber 30 may be configured to receive laser energy from the laser source 20 via the optical coupler 22, and the optical fiber 30 may be configured to output the laser energy through the distal end 32 of the optical fiber 30. The optical fiber 30 may include, for example, a core, one or more cladding layers about the core, a buffer layer about the cladding, a jacket, etc. The core may be made of a suitable material for the transmission of laser energy from the laser source 20. The core may be multi-mode and may have a step or graded index profile. The cladding may be a single or a double cladding that may be made of a hard polymer or silica. The buffer may be made of a hard polymer such as Tefzel®, for example. When the optical fiber 30 includes a jacket, the jacket may be made of Tefzel®, for example, or other polymers. The optical fiber 30 may be made of a suitable biocompatible material and may be flexible, for example, to traverse tortuous anatomy in the body.

The laser assembly 10 may also include a suitable catheter or endoscope 40 for inserting the distal end portion 12 of the laser assembly 10 into a patient's body. The endoscope 40 may define one or more lumens. In some embodiments, the endoscope 40 may include a single lumen that may receive various components such as the optical fiber 30. The endoscope 40 may have a proximal end configured to receive the distal end 32 of the optical fiber 30 and a distal end configured to be inserted into a patient's body for positioning the distal end 32 of the optical fiber 30 in an appropriate location for a laser-based surgical procedure. For example, to perform a surgical procedure near the prostate, the endoscope 40 may be used to place the distal end 32 of the optical fiber 30 at or near the prostate gland. The endoscope 40 may be made of a suitable biocompatible material and may include an elongate portion that may be flexible to allow the elongate portion to be maneuvered within the body. The endoscope 40 may also be configured to receive various other medical devices or tools through one or more lumens of the endoscope 40, such as, for example, irrigation and/or suction devices, forceps, drills, snares, needles, etc. In some embodiments, the endoscope 40 may include a fluid channel (not shown) coupled at a proximal end to a fluid source (not shown). The fluid channel may be used to irrigate an interior of the patient's body during a laser-based surgical procedure. In some embodiments, the endoscope 40 may include an optical device (not shown), e.g., including an eyepiece coupled to a proximal end of the endoscope 40. The optical device may include an optical fiber or other image transmission device, e.g., a wireless device, that may be disposed in or on the endoscope 40, e.g., in a lumen or on a distal end of the endoscope 40, to transmit an image signal to the surgeon. Such an embodiment allows a medical practitioner to view the interior of a patient's body through the eyepiece.

FIG. 3 shows the distal end portion 12 of the laser assembly 10, according to an exemplary embodiment.

The distal end 32 of the optical fiber 30 may form an angled portion 36 in the distal end portion 12 of the laser assembly 10. The angled portion 36 has an angled surface at the distal end 32 of the optical fiber 30. The angled surface is transverse to a plane that is perpendicular to a longitudinal axis of the optical fiber 30. The distal end portion 12 of the laser assembly 10 (including the angled portion 36) may be inserted into the patient's body to provide laser treatment. An optical beam (e.g., laser beam including laser energy) may be transmitted from the laser source 20, through the optical fiber 30 from its proximal end 34 to its distal end 32, and then through the angled portion 36 at the distal end 32 of the optical fiber 30. The angled portion 36 may be cleaved and/or polished to an appropriate angle configured to redirect laser energy in a lateral direction for side-firing transmission of laser energy to the area of treatment in the patient's body. Thus, the distal end 32 of the optical fiber 30 may include one or more members, elements, components, configurations, or shapes that may individually or collectively operate to transmit laser energy in a lateral direction offset from a longitudinal axis or centerline of the distal end 32 of the optical fiber 30.

The distal end 32 of the optical fiber 30 may be disposed within a channel 56 in a capillary tube 50 in the distal end portion 12 of the laser assembly 10. The capillary tube 50 may include a distal end 52 and a proximal end 54, and the channel 56 may extend longitudinally between the distal and proximal ends 52, 54. The capillary tube 50 may be made of, for example, at least one of silica, sapphire, glass, calcium fluoride, Cleartran™, multispectral zinc sulphide (MS ZnS), fused silica, gallium arsenide, gallium phosphide, plastic, Pyrex®, SF57, high index glass, silicon, zinc selenide, zinc sulfide, and/or other like materials. An outer surface of the distal end 32 of the optical fiber 30 may be positioned flush against an inner surface of the capillary tube 50, as shown in FIG. 3, and may be fused or attached to the inner surface of the capillary tube 50.

The optical fiber 30 may be disposed through a proximal part of the channel 56 in the capillary tube 50, and the distal end 52 of the capillary tube 50 may be closed, as shown in FIG. 3, e.g., by heating (to soften) and/or collapsing the distal end 52. The distal end 32 of the optical fiber 30 may be inserted into the proximal end 54 of the capillary tube 50 such that the channel 56 remains at least partially empty (except for air) and the distal end 52 of the capillary tube 50 may be distal to the angled portion 36 of the optical fiber 30. Since the channel 56 is at least partially empty, a gap 60 or air pocket is formed in the channel 56 at a location that is distal from the distal end 32 of the optical fiber 30.

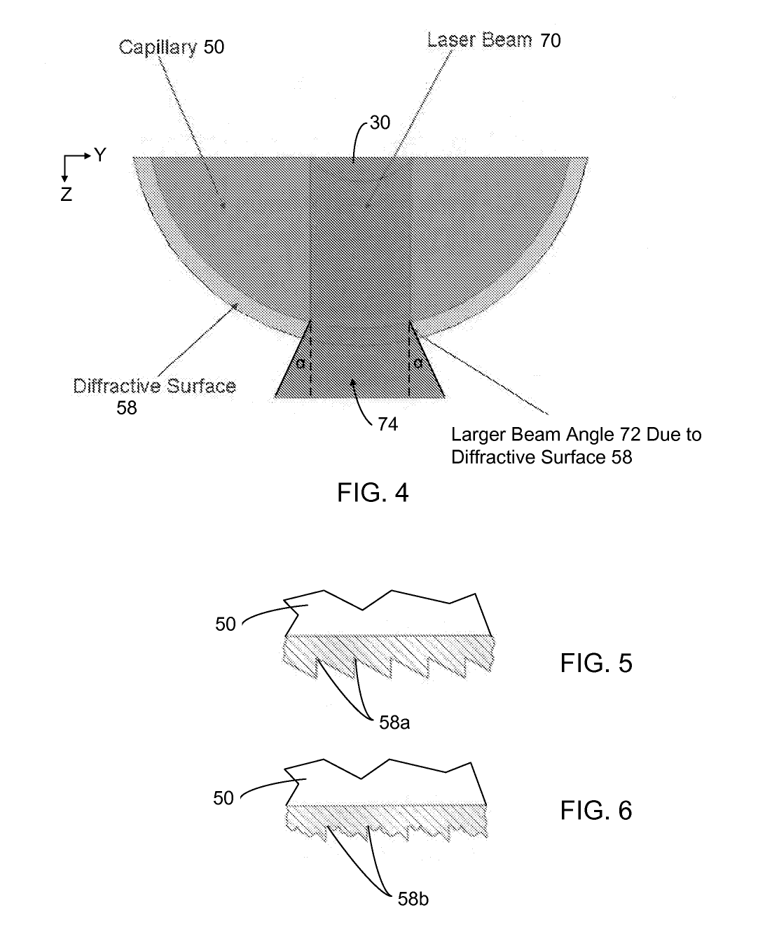

As described above, the optical fiber 30 is configured to receive at least one beam of laser energy from the laser source 20 (FIG. 2) and to transmit the beam of laser energy to the distal end 32 of the optical fiber 30. Then, the beam of laser energy may be emitted from the angled portion 36 of the optical fiber 30 generally in a lateral direction with respect to the optical fiber 30. As shown in FIGS. 3 and 4, the capillary tube 50 may include a diffractive surface 58 or diffraction grating aligned with the path of the laser energy emitted from the optical fiber 30.

FIGS. 3 and 4 show the beam of laser energy as it is transmitted from the optical fiber 30 and through the capillary tube 50. The beam 70 of laser energy emitted by the optical fiber 30 is directed through the capillary tube 50 and the diffractive surface 58. The longitudinal axis of the optical fiber 30 and the capillary tube 50 extends along the X-direction shown in FIG. 3, and the beam 70 of laser energy may be emitted from the optical fiber 30 generally perpendicular to the longitudinal axis of the of the optical fiber 30, e.g., generally along the Z-direction, as shown in FIGS. 3 and 4. The diffractive surface 58 is configured to diffract or disperse the beam 70 of laser energy. For example, the cross-sectional area of the beam 70 of laser energy emitted by the optical fiber 30 may be increased, and the beam 74 of laser energy with the increased cross-sectional area may be directed to the patient's tissue from the diffractive surface 58.

In the exemplary embodiment shown in FIGS. 3 and 4, the diffractive surface 58 may be configured to diffract the beam of laser energy such that the beam angle 72 may increase, e.g., by 2a. The term “beam angle” refers to a fan angle or angular spread of a beam of laser energy. The beam 70 of laser energy emitted by the optical fiber 30 may have a zero or relatively small beam angle. The beam 74 of laser energy emitted by the diffractive surface 58 may have a larger beam angle 72 and beam width, and therefore may create a larger spot size, e.g., larger diameter, on the patient's tissue. As a result, each pulse of laser energy may treat a larger surface area of the patient's tissue. The spot size on the patient's tissue depends on the beam angle 72 and the distance between the laser assembly 10 and the patient's tissue.

The diffractive surface 58 may include a plurality of grooves, etches, or other features that are created on the surface of the capillary tube 50. FIGS. 5 and 6 are partial cross-sectional views showing the profiles of grooves 58a, 58b of two exemplary diffractive surfaces. The grooves 58a, 58b may be relatively small, e.g., approximately 3 microns deep or smaller, and the depth of the grooves 58a, 58b may depend on the thickness of the capillary tube 50. As shown in FIGS. 5 and 6, the grooves 58a, 58b may be formed in a periodic pattern, such as a ramp or sawtooth wave (FIG. 5) or other pattern including one or more curves (e.g., sinusoid), teeth, triangles, torroids, a combination of one or more of these elements, etc. The pattern may be formed along one or more dimensions in the diffractive surface 58. For example, the pattern formed in the diffractive surface 58 may be repeated along the radial direction and/or along the longitudinal direction of the capillary tube 50. The size, shape, pattern, and other characteristics of the grooves 58a, 58b may be determined based on the particular application, e.g., the type of treatment intended for the patient's tissue.

The grooves 58a, 58b or other features of the diffractive surface 58 may be formed on the capillary tube 50 using conventional techniques for fabricating diffractive surfaces and diffraction gratings as known in the art, such as electron-beam fabrication techniques, gray scale technology, holography, mechanical ruling (e.g., using a diamond stylus), or other methods for fabricating small-scale three-dimensional structures.

The grooves 58a, 58b or other features of the diffractive surface 58 may be configured to cause the beam of laser energy to spread out along one or two dimensions. For example, as shown in FIGS. 3 and 4, the grooves 58a, 58b or other features of the diffractive surface 58 may diffract the beam of laser energy by increasing the beam angle 72 by 2a. As a result, the grooves 58a, 58b or other features of the diffractive surface 58 may be configured to increase the beam angle 72 to cause the beam of laser energy to spread out to in a radial direction to increase its diameter (or spot size), thereby increasing the size of the beam two-dimensionally. Alternatively, the grooves 58a, 58b or other features of the diffractive surface 58 may be configured to increase the beam angle 72 along one or more dimensions or directions, e.g., the (positive and/or negative) X-direction shown in FIG. 3, the (positive and/or negative) Y-direction shown in FIG. 4, and/or other directions. The grooves 58a, 58b or other features of the diffractive surface 58 may be configured to increase the beam angle 72 by different amounts or angles in different directions (e.g., the positive and/or negative X-directions, the positive and/or negative Y-directions, various ranges along a radial direction with respect to a beam axis or center axis of the beam, and/or other directions).

As shown in FIGS. 3 and 4, the diffractive surface 58 may be formed on the outer surface of the capillary tube 50. Alternatively, the grooves 58a, 58b or other features configured to diffract the beam of laser energy may be formed within the capillary tube 50 between the inner and outer surfaces of the capillary tube 50, on an inner surface of the capillary tube 50, etc. Alternatively, the diffractive surface 58 may be a layer that is superimposed (placed or laid over) the outer surface and/or the inner surface of the capillary tube 50 and attached to the capillary tube 50.

The size of the diffractive surface 58 on the capillary tube 50 (e.g., in the longitudinal direction, radial direction, etc.) may depend on the size of the beam of laser energy emitted from the optical fiber 30. For example, the diffractive surface 58 may be sized such that the diffractive surface 58 is large enough to intersect the entire beam 70 of laser energy emitted from the optical fiber 30, as shown in FIG. 4, or a portion thereof.

Any aspect set forth in any embodiment may be used with any other embodiment set forth herein. Every device and apparatus set forth herein may be used in any suitable medical procedure, may be advanced through any suitable body lumen and body cavity, and may be used for treatment of any suitable body portion. For example, the apparatuses and methods described herein may be used in any natural body lumen or tract, including those accessed orally, vaginally, or rectally.

It will be apparent to those skilled in the art that various modifications and variations can be made in the disclosed systems and processes without departing from the scope of the invention. Other embodiments of the invention will be apparent to those skilled in the art from consideration of the specification and practice of the invention disclosed herein. It is intended that the specification and examples be considered as exemplary only. The following disclosure identifies some other exemplary embodiments.

In some embodiments, an apparatus may include an optical fiber having a distal end with a distal surface configured to emit a beam of energy at an angle relative to a longitudinal axis of the optical fiber. The apparatus may also include a tube including a channel and a diffractive portion. The distal end of the optical fiber may be disposed in the channel of the tube such that the beam of energy emitted from the optical fiber passes through the diffractive portion. The beam of energy emitted from the diffractive portion may have a greater beam angle than the beam of energy directed to the diffractive portion.

In some embodiments, the beam angle may be configured to increase along one or more of a longitudinal direction parallel to the longitudinal axis, a direction perpendicular to the longitudinal direction, and a radial direction.

In some embodiments, the diffractive portion may be located on an outer surface of the tube.

In some embodiments, the diffractive portion may include a plurality of grooves.

In some embodiments, the grooves may be approximately 3 microns deep or smaller.

In some embodiments, the diffractive portion of the tube may include a periodic pattern.

In some embodiments, the periodic pattern may include at least one of a ramp or a curve.

In some embodiments, the beam of energy emitted from the diffractive portion may have a larger beam angle, beam width, or spot size than the beam of energy directed to the diffractive portion.

In some embodiments, the optical fiber may be disposed in the tube such that a pocket is formed in the channel of the tube between the distal end of the optical fiber and the distal end of the tube.

In some embodiments, an outer surface of the optical fiber may contact an inner surface of the tube.

In some embodiments, an outer surface of the optical fiber may be attached to an inner surface of the tube.

In some embodiments, the apparatus may further include a laser source coupled to the optical fiber and configured to produce the beam of energy.

In some embodiments, the distal surface may include an angled surface configured to direct at least a portion of the beam of energy laterally from the optical fiber.

In some embodiments, a method of transmitting a beam of energy may include transmitting a beam of energy through an optical fiber and toward a distal end of the optical fiber. The distal end of the optical fiber may be disposed within a channel in a tube. The method may also include emitting the beam of energy from the optical fiber at an angle relative to a longitudinal axis of the optical fiber and transmitting the beam of energy through a diffractive portion to increase a beam angle of the beam of energy.

In some embodiments, the beam angle of the beam of energy may be increased using a plurality of grooves in the diffractive portion.

In some embodiments, the method may further include producing the beam of energy from a laser source, and transmitting the beam of energy from the laser source to the optical fiber.

In some embodiments, the method may further include directing the beam of energy from the tube toward tissue of a patient.

In some embodiments, a laser assembly may include a laser source configured to produce a beam of energy, and an optical fiber having a proximal end coupled to the laser source and a distal end. The distal end of the optical fiber may have a distal surface configured to emit the beam of energy at an angle relative to a longitudinal axis of the optical fiber. The laser assembly may also include a tube including a channel and a diffractive portion. The distal end of the optical fiber may be disposed in the channel of the tube such that the beam of energy emitted from the optical fiber passes through the diffractive portion of the tube. The diffractive portion may be configured to increase a beam angle of the beam of energy.

In some embodiments, the beam of energy may be configured to be directed from the diffractive portion toward tissue of a patent.

In some embodiments, the diffractive portion may include a plurality of grooves on an outer surface of the tube.

What is claimed is:

1. An apparatus comprising:
an optical fiber having a distal end with a distal surface configured to emit a beam of energy at an angle relative to a longitudinal axis of the optical fiber; and
a tube including a channel and a diffractive portion, the distal end of the optical fiber being disposed in the channel of the tube such that the beam of energy emitted from the optical fiber passes through the diffractive portion,
wherein the beam of energy emitted from the diffractive portion has a greater beam angle than the beam of energy directed to the diffractive portion.

2. The apparatus of claim 1, wherein the beam angle is configured to increase along one or more of a longitudinal direction parallel to the longitudinal axis, a direction perpendicular to the longitudinal direction, and a radial direction.

3. The apparatus of claim 1, wherein the diffractive portion is located on an outer surface of the tube.

4. The apparatus of claim 1, wherein the diffractive portion includes a plurality of grooves.

5. The apparatus of claim 4, wherein the grooves are approximately 3 microns deep or smaller.

6. The apparatus of claim 1, wherein the diffractive portion of the tube includes a periodic pattern.

7. The apparatus of claim 6, wherein the periodic pattern includes at least one of a ramp or a curve.

8. The apparatus of claim 1, wherein the beam of energy emitted from the diffractive portion has a larger beam angle, beam width, or spot size than the beam of energy directed to the diffractive portion.

9. The apparatus of claim 1, wherein the optical fiber is disposed in the tube such that a pocket is formed in the channel of the tube between the distal end of the optical fiber and the distal end of the tube.

10. The apparatus of claim 1, wherein an outer surface of the optical fiber contacts an inner surface of the tube.

11. The apparatus of claim 1, wherein an outer surface of the optical fiber is attached to an inner surface of the tube.

12. The apparatus of claim 1, further including a laser source coupled to the optical fiber and configured to produce the beam of energy.

13. The apparatus of claim 1, wherein the distal surface includes an angled surface configured to direct at least a portion of the beam of energy laterally from the optical fiber.

14. A method of transmitting a beam of energy, the method comprising:
transmitting a beam of energy through an optical fiber and toward a distal end of the optical fiber, the distal end of the optical fiber being disposed within a channel in a tube;
emitting the beam of energy from the optical fiber at an angle relative to a longitudinal axis of the optical fiber; and
transmitting the beam of energy through a diffractive portion to increase a beam angle of the beam of energy.

15. The method of claim 14, wherein the beam angle of the beam of energy is increased using a plurality of grooves in the diffractive portion.

16. The method of claim 14, further including producing the beam of energy from a laser source, and transmitting the beam of energy from the laser source to the optical fiber.

17. The method of claim 14, further including directing the beam of energy from the tube toward tissue of a patient.

18. A laser assembly comprising:
a laser source configured to produce a beam of energy;
an optical fiber having a proximal end coupled to the laser source and a distal end, the distal end of the optical fiber having a distal surface configured to emit the beam of energy at an angle relative to a longitudinal axis of the optical fiber; and
a tube including a channel and a diffractive portion, the distal end of the optical fiber being disposed in the channel of the tube such that the beam of energy emitted from the optical fiber passes through the diffractive portion of the tube,
wherein the diffractive portion is configured to increase a beam angle of the beam of energy.

19. The laser assembly of claim 18, wherein the beam of energy is configured to be directed from the diffractive portion toward tissue of a patent.

20. The laser assembly of claim 18, wherein the diffractive portion includes a plurality of grooves on an outer surface of the tube.
